(19) United States
(12) Patent Application Publication
(10) Pub. No.: US 2025/0034374 A1
(43) Pub. Date: Jan. 30, 2025

(54) COMPOSITION FOR OBTAINING PALLETS

(71) Applicant: ADEZAN INDUSTRIA DE EMBALAGENS E SERVICOS LTDA., SÃO PAULO (BR)

(72) Inventor: Cesar Valentim ZANCHET, SÃO PAULO (BR)

(21) Appl. No.: 18/227,023

(22) Filed: Jul. 27, 2023

(51) Int. Cl. C08L 17/00; C08L 67/02

(52) U.S. Cl. CPC C08L 17/00; C08L 67/02; C08L 2205/03

(57) ABSTRACT

A composition for obtaining pallets pertaining to the transportation accessory field, more particularly, a composition of recycled materials for obtaining pallets, thus making good use of rubber and plastic based waste materials that are designed to be discarded into landfills, transforming same into a useful product to be used in the transportation field, thus attaining practical, safe and functional advantageous results. The composition for obtaining pallets is basically comprised of recycled materials (plastic or rubber), ground styrofoam, an inner structure, and a binding resin.

### FIELD OF THE INVENTION

The present patent is directed to a composition for obtaining pallets pertaining to the transportation accessory field, more particularly, a composition of recycled materials for obtaining pallets, thus making good use of rubber and plastic based waste materials that were designed to be discarded into landfills, transforming same into a useful product to be used in the transportation field, thus attaining practical, safe and functional advantageous results.

### STATE OF THE ART

The environmental issue caused by the discard of plastic and rubber materials is notorious. Thus, the recycling of said materials is essential and many companies are striving to innovate by using products containing such recycled materials. Nowadays, the concern of the companies with the generation and discard of waste materials is becoming more and more important in the supply chain.

With respect to pallets used for transporting packages, the main present concern for this logistic is that use is made of wood pallets which exhibit some deficiencies such as: reduced useful life and likelihood of damaged products due to the use of nails.

As a part of the state of the art, reference is made to patent document BR112015021319-7, published on Oct. 23, 2014, entitled “A PLASTIC PALLET PROVIDED WITH REINFORCEMENTS FOR REDUCING FLEXURE, AND A PROCESS FOR RECYCLING PALLETS”, the abstract of which reads as follows: “‘A plastic pallet provided with reinforcements for reducing flexure and a process for recycling pallets’, the present invention being directed to a plastic pallet comprising reinforcements such as inserts, which pallet is molded from a thermoplastic material and is highly resistant to the flexure generated by the load when mechanisms for transporting and handling said pallets are used, such as when the pallet is submitted to the piling of heavy load, and the plastic pallet provided with reinforcements in accordance with the present invention is reinforced with inserts strategically positioned on the cover of the pallet for the purpose of increasing the rigidity of the general structure of said pallet, and fully incorporated into the plastic foam material that is injected into the columns of the plastic pallet, thus making it impossible to move and extract said inserts. Further, the plastic pallet provided with reinforcements in accordance with the present invention is lighter when compared to conventional pallets, including other reinforced pallets, thus providing improved characteristics in relation to the structural support. In addition, when the useful life of the plastic pallet provided with reinforcements in accordance with the present invention approaches the end, it can be fully recycled, thus reducing the environmental impact caused when such types of plastic pallets are discarded.”

Despite the fact that the above-described document is directed to a plastic pallet which can be recycled, it solves the problem of wood pallets, but it is not comprised of recycled materials, and thus it contributes to solve the problem of discarding plastic materials but recycled materials are not eliminated.

Moreover, instead of wood pallets, the existing plastic pallets are produced in injecting machines and used in regular supermarket chains and stored in logistic warehouses. Their capacity ranges from 1 to 3 tons per 1,000×1,200 mm pellet. Therefore, they cannot transport loads weighing from 10 to 16 tons as, for instance, in the case of aluminum coils.

### SUMMARY OF THE INVENTION

Therefore, one of the objects of the present invention is to provide a new safe product that uses recycled materials such as plastic and rubber, thus providing an additional option in the transportation market and concomitantly being ecofriendly.

Another object is to provide a product originated from discarded materials such as tires or PET bottles, 100% recycled raw material. The useful life thereof is at least 10 times that of a conventional product currently used and it can be ground and reused when its cycle of life ends.

This new alternative brings about an important innovation for the productive sectors since a long-lasting reusable product is introduced, and it can be ground and recycled when its cycle of life ends, thus starting a new cycle.

The composition for obtaining pallets is basically comprised of: recycled materials (plastic or rubber), ground styrofoam, an inner structure and a binding resin.

### DETAILED DESCRIPTION OF THE INVENTION

The composition for obtaining pallets comprises the following compounds by weight:
50% to 70% recycled materials such as ground tire rubber, and ground plastics such as PET (mixture of ground plastics);
3% to 6% ground styrofoam;
5% to 15% of an inner structure consisting of wood, fiberglass or nylon;
25% to 35% of a two-component polyurethane based binding resin, since we can control the required time to safely carry out the mixing and pressing cycle.

### Examples

In an exemplary attainment of the composition comprising a mass of ground tire rubber, the following materials were used:
ground tire rubber: 57%
ground styrofoam: 4%
wood inner structure: 13%
two-component polyurethane based binding resin: 26%
total: 100%

In a second exemplary attainment of the composition comprising a mass of ground PET (plastics), the following materials were used:
PET (mixture of ground plastics): 60%
ground styrofoam: 5%
nylon or fiberglass: 5%
two-component polyurethane based binding resin: 30%
total: 100%

### Advantages of the Invention

The following advantages can be obtained when the composition for obtaining pallets is used:
another option of using recyclable materials is provided, thus providing same with environmentally friendly characteristics;
a higher pallet resistance is provided;
it is possible to use pallets in every chain where reverse logistic can be applied;
a package of services that performs the whole reuse management is contemplated, thus following-up all the cycles, and keeping track of the pallets from the first time they are transported to the time they are recycled;
this alternative uses recycled material consisting of ground tire rubber or ground PET mixed with binding resin, fiber and aggregates to reduce the weight thereof, creating a consistent mass in terms of resistance to “Compression and Flexure”;
besides providing a perfect conditioning for transported products, it protects against impacts and creates an anti-sliding surface, thus preventing displacement on trucks as well as displacement of coils on the pallet;
it allows for the composition to be pressed, using a mold designed according to the need, and the mass is poured on said mold and pressed after the mixture is made, and it is not a plastic injection process;
the resistance to compression and flexure was evidenced through tests conducted in laboratories;
it allows for a useful life 10 times longer than conventional wood pallets, and it can be ground and reused, thus constituting a cyclical process without the generation of debris, and therefore it is “ecofriendly”.

It should be understood that the preferred embodiments mentioned here are merely illustrative of the present invention. Numerous variations in design and use of the present invention may be contemplated in view of the following claims without straying from the intended scope and field of the invention herein disclosed.

1. A composition for obtaining pallets, comprising the following compounds by weight:
50% to 70% recycled materials;
3% to 6% ground styrofoam;
5% to 15% of an inner structure; and
25% to 35% of a binding resin.

2. The composition according to claim 1, wherein the recycled materials comprise ground tire rubber and ground plastic.

3. The composition according to claim 1, wherein the ground plastic is PET or a mix of suitable ground plastics.

4. The composition according to claim 1, wherein the inner structure is selected from the group consisting of wood, fiberglass, and nylon.

5. The composition according to claim 1, wherein the binding resin is a two-component polyurethane based resin.
